(19) United States
(12) Patent Application Publication
(10) Pub. No.: US 2012/0048823 A1
(43) Pub. Date: Mar. 1, 2012

(54) HITCH HOIST SYSTEMS

(76) Inventor: Michael Eugene Kriner, Brockport, PA (US)

(21) Appl. No.: 13/189,044

(22) Filed: Jul. 22, 2011

Related U.S. Application Data
(60) Provisional application No. 61/378,084, filed on Aug. 30, 2010.

(51) Int. Cl. B66C 23/44; B66C 23/62; B66C 23/36; B66C 23/06

(52) U.S. Cl. 212/180; 212/261; 212/238; 212/270

(57) ABSTRACT

Hitch Hoist system provides an effective and efficient means through which users may lift heavy objects into the backs of trucks. This innovative product preferably features four main components, including two legs, a coupling tee, and a boom containing a winch. The components are preferably held together using ordinary hitch pins, and can therefore be easily assembled and disassembled whenever necessary. Consumers may use this product to lift extremely heavy objects when help is not available, or when conserving time and labor is necessary. The present invention is convenient for home use, military use, as well as use in junkyards, farms, or construction sites.

### CROSS-REFERENCE TO RELATED APPLICATION

The present application is related to and claims priority from prior provisional application Ser. No. 61/378,084, filed Aug. 30, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of hoists and more specifically relates to vehicle hitch-mounted hoists.

### 2. DESCRIPTION OF THE RELATED ART

Many different job tasks require individuals to lift extremely heavy and/or cumbersome objects. These objects may be required to be lifted into/onto vehicles for transport. Certain lightweight objects can be lifted by one or two individuals, but this may be very labor-intensive and time-consuming, as well as it may present the potential for serious back strain and injuries. Other objects can weigh many hundreds of pounds, and therefore cannot be lifted by people. Levering systems or hoists may be used in these instances.

A hoist is a device typically used for lifting and/or lowering a load. Hoists may be built into buildings or may be free-standing. Built-in hoist systems may lift extremely heavy loads, but are not typically portable in nature. These style hoists may also be expensive to build and maintain. Machines and equipment designed to lift excessively heavy objects may not be compact or portable, and therefore may not be available for immediate use at all times and in remote locations. Free-standing versions of hoists normally are able to lift only small loads and may be cumbersome to operate over uneven surfaces. Additionally, since the free-standing versions are small and light they don't usually have much mass so are prone to tipping and thus may be dangerous to use. Neither the built-in or free-standing versions of hoists are typically designed for outdoor use.

Various attempts have been made to solve the above-mentioned problems such as those found in U.S. Pat. Nos. 5,211,526; 4,419,038; 5,540,537; 4,881,864; 5,064,078; and 4,746,263. This prior art is representative of hoists. None of the above inventions and patents, taken either singly or in combination, is seen to describe the invention as claimed.

Ideally, a hitch hoist system should be user-friendly and, yet, would operate reliably and be manufactured at a modest expense. Thus, a need exists for a reliable portable hitch hoist system to avoid the above-mentioned problems.

### BRIEF SUMMARY OF THE INVENTION

In view of the foregoing disadvantages inherent in the known hoist art, the present invention provides a novel portable hitch hoist system. The general purpose of the present invention, which will be described subsequently in greater detail is to provide a convenient and safe lifting (and lowering) means for use in conjunction with a vehicle.

Hitch Hoist of the present invention generally provides an effective and efficient means through which users may lift heavy objects into the backs of trucks. This innovative product preferably features four main components, including two leg jacks (hereinafter referred to as first and second leg jacks—the first being smaller than the second), a coupling tee, and a boom (beam) containing a winch. The components are preferably held together using ordinary hitch pins (or other suitable fastening means may be used), and can therefore be easily assembled and disassembled whenever necessary. Consumers may use this product to lift extremely heavy objects when help is not available, or when conserving time and labor is necessary. The present invention is ideal for home use, military use, as well as use in junkyards, farms, or construction sites.

More specifically, a portable hitch hoist system is disclosed herein preferably comprising: at least one first leg jack; at least one second leg jack; at least one coupler, the coupler comprises a coupling tee; a plurality of connectors (preferably hitch pins); a frame assembly having a beam, the beam being hydraulically-operated and adjustable in relation to the frame; and at least one winch with a windable (and unwindable—spooled) cable with a hook (or other equivalent attachment means.)

The first leg jack and said second leg jack are coupled together via the coupler; the first leg jack comprising a stabilizer and the second leg jack comprises a drop leg. The drop leg is able to move through about 29 inches of linear travel in relation to the frame. In the preferred embodiment, the first leg jack can hold up to about 2000 pounds and the second leg jack can hold up to about 8000 pounds. The first and second leg jack (via the drop leg) are independently-operably-adjustable to match the contour of a ground surface (regardless whether even or uneven) via rotatable adjustment via a crank or other. The first leg jack and the coupler comprise an outrigger so as to provide stabilization means for the system while lifting heavy objects by displacing the load along the length of a member and thereby maintaining a lower point of gravity.

The first leg jack is preferably parallel to the second leg jack both of which retain a perpendicular relationship to the ground surface (on a similar plane) during an in-use condition (while lifting objects.) The coupler preferably provides a connection to a hitch receiver located on a vehicle such as to properly anchor the portable hitch hoist system to a sizable mass, this in combination with the outrigger system providing stability and safety during in-use conditions. The portable hitch hoist system is removably attachable to the vehicle, the vehicle acting in a capacity of an anchor such that the at least one item is able to be repeatedly moved between unlifted and lifted conditions. This combination is also convenient in that the user is able to lift the object into the vehicle (truck box or other) with relative ease (because the boom can rotate through 360 degrees) and/or onto a trailer or other carrier for transport.

The coupling tee may be used to couple the first leg jack and second leg jack to the hitch receiver; wherein the plurality of connectors are used to connect the beam to the frame, the first and second leg jacks to the coupler, and the coupler to the hitch receiver into an assembled condition ready to lift objects. The portable hitch hoist system is also disassembleable during a non-use period for storage and/or transport making it convenient to move it between locations. Of additional convenience is the feature that the portable hitch hoist system is readily transportable in a coupled relationship (to the hitch receiver), wherein the first leg jack and said second leg jack are in retracted (up) positions. This provides that the portable hitch hoist system is already assembled for use and doesn't need to be assembled before ‘picking’/lifting actions commence, thus saving time. The winch is removably coupled to the frame such that the windable cable is able to be attached to at least one liftable item to be moved vertically and/or horizontally within an envelope via the beam, the beam being manipulatable by a hydraulic ram (operated manually or non-manually by the user.)

The portable hitch hoist system comprises a kit as also disclosed herein, the kit including: the first and second leg jacks; a coupler; connectors; a frame (assembly) having a beam; a winch (manual or electric); and a set of user instructions.

A method is described herein for using a portable hitch hoist system preferably comprising the steps of: inserting a coupler as a connection to a hitch receiver located on a vehicle; assembling the portable hitch hoist system including a first leg jack, a second leg jack, a coupler, a frame assembly including a beam, and a winch to the coupler via a plurality of connectors; operating the assembled portable hitch hoist system using the vehicle as an anchor to lift at least one movable item; and optionally disassembling the portable hitch hoist system and storing for at least one future use. Further, as mentioned above the portable hitch hoist system may be transported in an assembled condition as coupled to the hitch receiver.

The present invention holds significant improvements and serves as a portable hitch hoist system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, hitch hoist systems, constructed and operative according to the teachings of the present invention.

FIG. 1 shows a perspective view illustrating a hitch hoist system in an assembled transport condition according to an embodiment of the present invention.

FIG. 2 shows a perspective view illustrating the hitch hoist system in an in-use condition according to an embodiment of the present invention.

FIG. 3a is a perspective view illustrating the hitch hoist system in an in-use condition as ‘hooked’ to another object being lifted according to an embodiment of the present invention of FIG. 2.

FIG. 3b is a perspective view illustrating the hitch hoist system in an in-use condition as ‘hooked’ to another object being lifted and lowered into a vehicle according to an embodiment of the present invention of FIG. 2.

FIG. 4 is a perspective view illustrating the hitch hoist system in an unloaded condition according to an embodiment of the present invention of FIG. 2.

FIG. 5A is a perspective view of a disassembled kit of the hitch hoist system (for transport or storage) according to an embodiment of the present invention of FIGS. 1-4.

FIG. 5B is a perspective view of a winch of the hitch hoist system according to an embodiment of the present invention of FIGS. 1-5A.

FIG. 6 is a perspective view of the hitch hoist system as used to provide a mobile work center using a vice according to an embodiment of the present invention of FIG. 2.

The various embodiments of the present invention will hereinafter be described in conjunction with the appended drawings, wherein like designations denote like elements.

### DETAILED DESCRIPTION

As discussed above, embodiments of the present invention relate to a hoist device and more particularly to a portable hitch hoist system as used to improve the convenience and safety while lifting and lowering items into a vehicle, using the vehicle as a stabilizing means.

Referring now generally to the present invention, the Hitch Hoist (system) provides an efficient and convenient means and method for lifting objects which are too heavy for one or two individuals alone to lift. The instant invention may comprise four main components, including a small (first) leg jack, a large (second) leg jack, a coupling tee, and a hydraulic boom containing a winch. All components may comprise tubular steel, and may be connected (assembled) using pins. The small leg jack can be capable of withstanding 2,000 pounds, and the large leg jack may be capable of withstanding 8,000 pounds. The large leg jack can also include a drop leg, having approximately 29″ of travel, and the boom may pivot 360 degrees for optimal adjustability, particularly on uneven ground. Weight may be added to the outrigger if desired to increase stability.

The small leg jack may provide stability while the device is in use. The jacks may be connected by the coupling tee, which can be applied to the desired vehicle. The boom, which may be a three-ton hydraulic boom (larger and smaller capacity may be used), can be connected to the large leg jack. The winch affixed to the boom may include two gears and an 840 pound-capacity cable (larger and smaller capacity versions may be used.) The winch itself may possess a 2500 pound capacity (larger and smaller capacity versions may be used.) Consumers may easily assemble or disassemble this product, and may store the parts in the bed of a truck. The present invention can be disassembled into the four components mentioned above for ease of transport between loading and unloading locations.

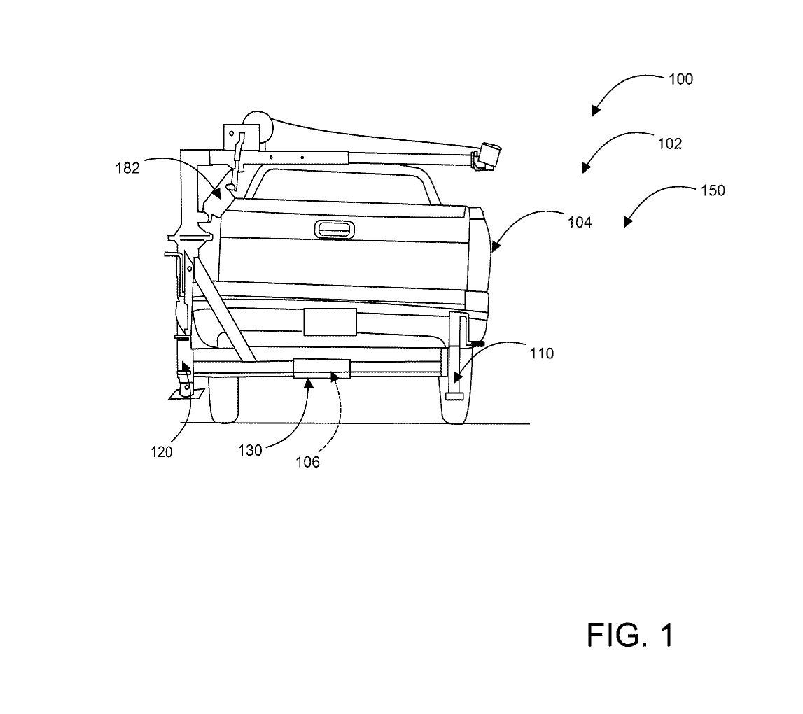

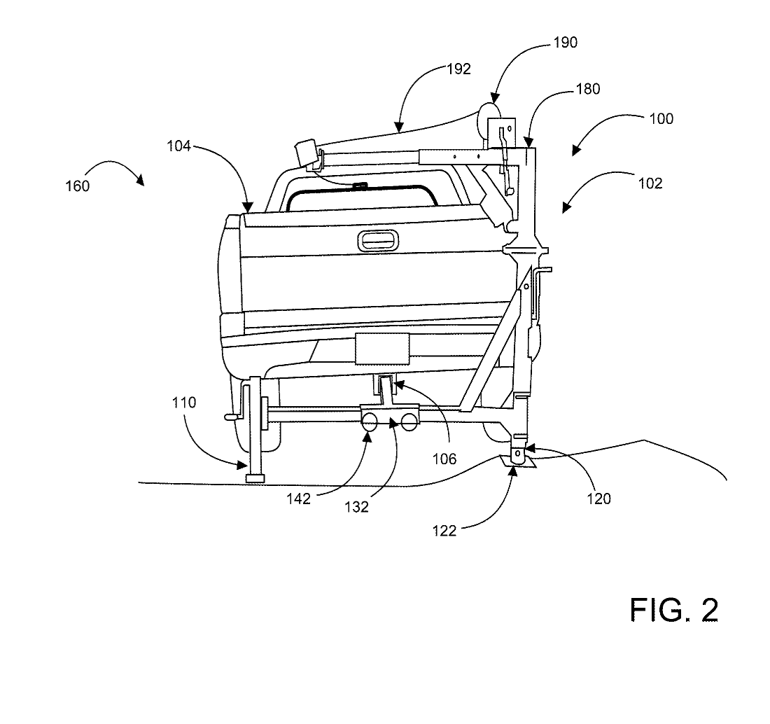

Referring to the drawings by numerals of reference there is shown in FIGS. 1 and 2, perspective views, FIG. 1 illustrating hitch hoist system 100 in an assembled transport condition 150 and FIG. 2 showing a perspective view illustrating hitch hoist system 100 in an in-use condition 160 according to an embodiment of the present invention.

Portable hitch hoist system 100 within the present invention preferably comprises: at least one first leg jack 110; at least one second leg jack 120; at least one coupler 130; a plurality of connectors 140; frame 170 having at least one boom (boom comprising beam 180), beam 180 being preferably hydraulically-operated via a bottle jack or other suitable means; and at least one winch 190 with a windable cable 192 with at least one hook 194 (or other suitably equivalent securing means.) Upon reading this specification, it should be appreciated that, under appropriate circumstances, considering such issues as user preferences, design preference, structural requirements, marketing preferences, cost, available materials, technological advances, etc., other winching arrangements such as, for example, cables of braided/non-braided wire, rope, chain, etc., may be sufficient. Additionally, other securing means other than hooks may be used such as clasps, clamps, magnets, and the like and still be considered within the scope of the present invention.

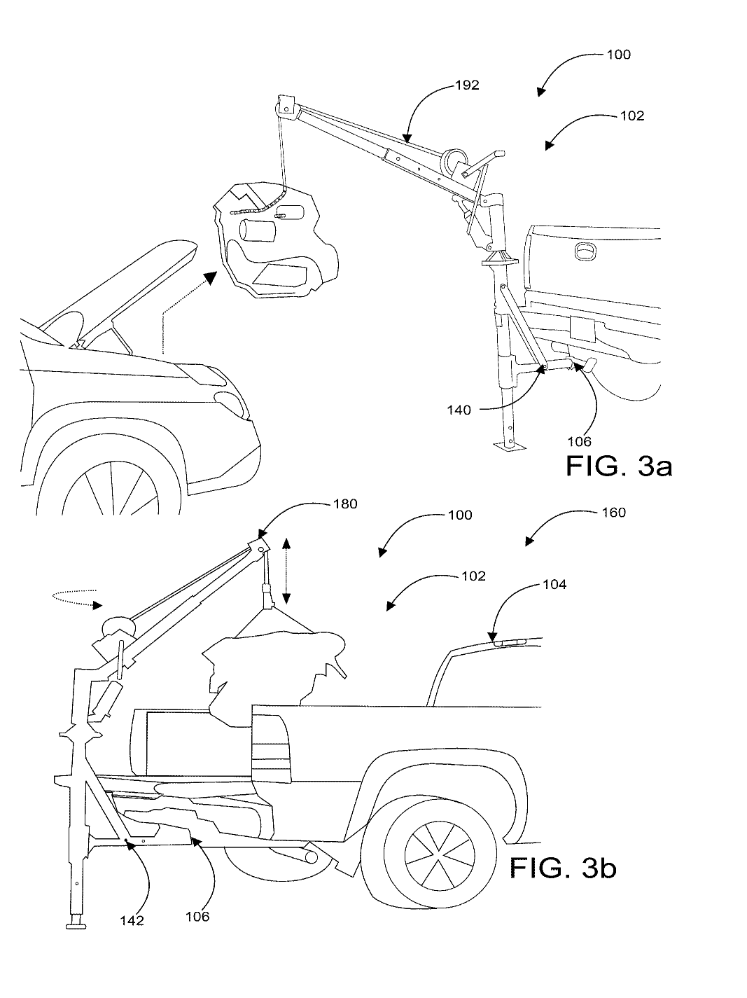

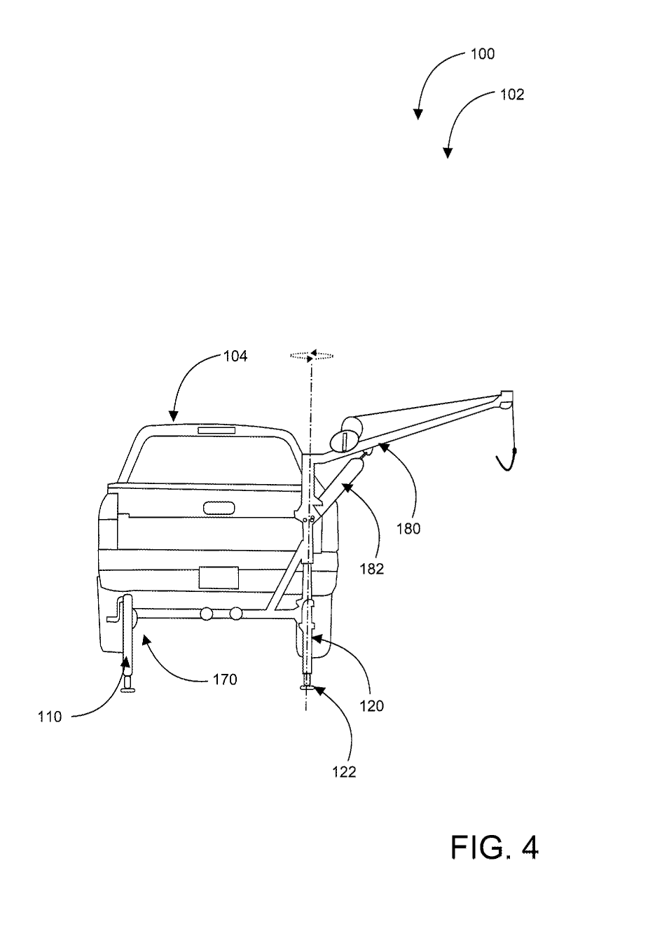

In the particular embodiment shown, first leg jack 110 and second leg jack 120 comprise implement jacks that may be rotated up or down on a screw by turning a crank handle (FIG. 1 showing the rotated up position used for assembled transport condition 150 and FIG. 2 showing the rotated down position for in-use condition 160, also shown in FIGS. 3a-4.) Rotated up position serves to provide clearance of first leg jack 110 and second leg jack 120 from road surfaces and obstacles so they are not damaged during transport occasions. First leg jack 110 and second leg jack 120 are preferably removably coupled together via coupler 130, wherein connectors 140 are preferably used. First leg jack 110 and second leg jack 120 are oriented on the same plane, but a distance apart such that stability may be suitably achieved, thereby coupler 130 provides a force transferring means between first leg jack 110, second leg jack 120 and vehicle 104; wherein weight distribution is thereby distributed as indicated in FIG. 2. Coupler 130 provides a connection to hitch receiver 106 located on vehicle 104; coupler 130 preferably comprising a coupling tee 132, as shown.

As previously mentioned a plurality of connectors 140 may be used, connectors 140 preferably comprising hitch pins 142 which are used to connect beam 180 to frame 170 (at a user-preferred distance as per lifting weight, size, etc.), first leg jack 110 and second leg jack 120 to coupler 130, and coupler 130 to hitch receiver 106. Upon reading this specification, it should be appreciated that, under appropriate circumstances, considering such issues as user preferences, design preference, structural requirements, marketing preferences, cost, available materials, technological advances, etc., other connecting arrangements such as, for example, bolts, keys, pins with spring-loaded rings, or combinations thereof, etc., may be sufficient. Hitch pins 142 are preferred due to their ready availability, durability, low cost and efficiency of use.

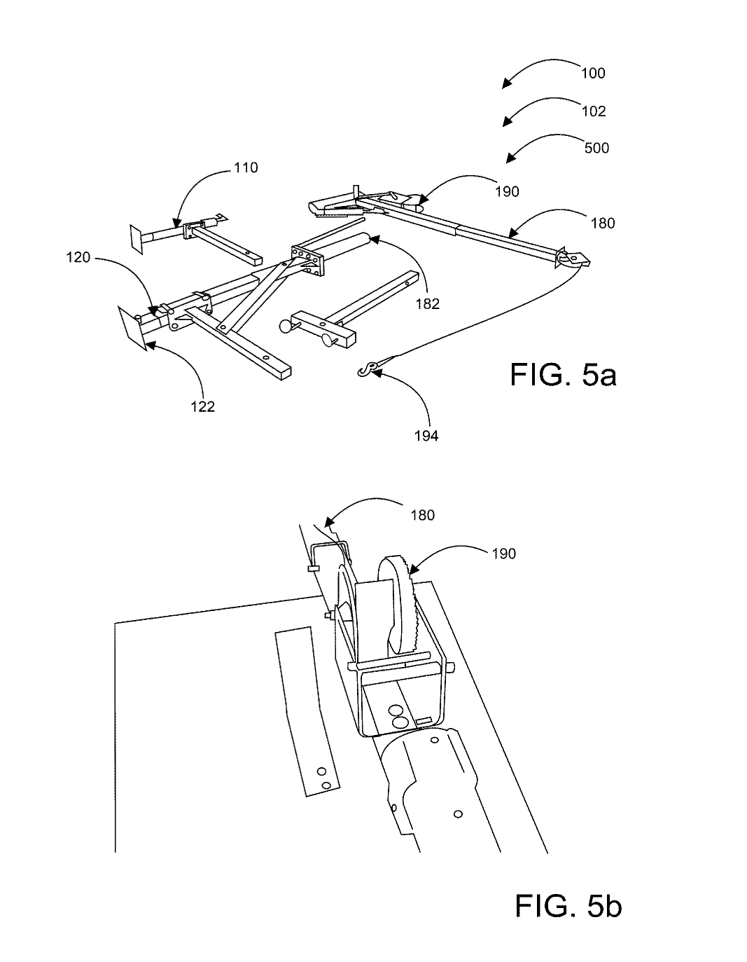

Winch 190 is removably coupled to frame 170 (also referring now to FIG. 5B) such that windable cable 192 is able to be attached to at least one item (via winding or unwinding cable 192) to be lifted via beam 180, beam 180 being manipulatable by at least one hydraulic ram 182 (bottle jack style or other.)

In this way hitch hoist system 100 comprises portable hitch hoist system 102 which is removably attachable to vehicle 104, vehicle 104 acting in a capacity of an anchor such that said at least one item is able to be repeatedly moved between unlifted and lifted conditions, as shown in FIGS. 2-4. Portable hitch hoist system 102 is transportable in either a coupled relationship to hitch receiver 106, (assembled transport condition 150 as shown in FIG. 1); wherein first leg jack 110 and second leg jack 120 are in retracted positions or alternately in a disassembled condition (FIG. 5A.)

Referring specifically now to FIG. 2 showing a perspective view illustrating portable hitch hoist system 102 in an in-use condition 160 according to an embodiment of the present invention, wherein an object has been lifted into vehicle 104 and is now at rest (stationary) for transport between locations.

Portable hitch hoist system 102 preferably comprises first leg jack 110 wherein first leg jack 110 comprises a smaller size than second leg jack 120. Second leg jack 120 comprises drop leg 122. Drop leg 122 comprises about 29 inches of travel in relation to frame 170, suitable to extend to meet virtually any planar ground surface. FIGS. 2, 3a and 3b show drop leg 122 in a ‘down’ position in contact with ground surface. First leg jack 110 and second leg jack 120 may be oriented at different lengths to accommodate varying ground surfaces. This is a convenient feature for use on uneven surface such as those found in outdoor environments. As such, portable hitch hoist system 102 may be used to load and unload various items, also alluded to in FIGS. 3a-4.

Referring now to FIGS. 3a and 3b, perspective views illustrating hitch hoist system 100 in an in-use condition 160 as ‘hooked’ to another object (an engine) being lifted and lowered according to an embodiment of the present invention of FIG. 2. Upon reading this specification, it should be appreciated that, under appropriate circumstances, considering such issues as user preferences, design preference, structural requirements, marketing preferences, cost, available materials, technological advances, etc., other items such as, for example, tanks, crates, pallets, or virtually any loadable liftable item etc., may be sufficient. The tank and engine as shown are shown as exemplary means and the scope of the invention is not to be construed as being in any way limited to these items, but rather that they have been provided as examples of the present invention's capability such that the invention is embodied in an in-use condition.

First leg jack 110 comprises a stabilizer (acting as an outrigger) as also shown clearly in FIG. 2 in this way the present invention is suitably stabilized from tipping by first leg jack 110 and by hitch receiver 106 because of its connection to vehicle 104. This stability increases safety in use and minimizes damage to items being lifted. Coupling tee 132 is preferably used to couple first leg jack 110 and second leg jack 120 to hitch receiver 106. Using this particular configuration first leg jack 110 can hold up to about 2000 pounds and second leg jack 120 can hold up to about 8000 pounds. Second leg jack 120 is distributed more of the vertical force travelling downwardly as it is located closer in proximity to the item being lifted or lowered. The remaining downward forces are distributed to first leg jack 110 such they are both able to withstand the forces to avoid deformation of portable hitch hoist system 102.

First leg jack 110 and second leg jack 120 comprise feet to further distribute the load on the ground surface such that first leg jack 110 and second leg jack 120 remain above the ground surface, not sink into the ground. Additionally, this provides that first leg jack 110 and second leg jack 120 remain at substantially perpendicular relationships with the ground and first leg jack 110 and second leg jack 120 remain substantially parallel to each other to avoid potential for tipping or buckling under stress. It should be appreciated that it is preferable to use the present invention on stable, solid ground to maintain the desired positioning and stability. As eluded to above, first leg jack 110 and second leg jack 120 are independently-operably-adjustable to match a ground surface. First leg jack 110 and coupler 130 comprise an outrigger (outrigging means for weight, force distribution.) Ideally, first leg jack 110 is parallel to second leg jack 120 and both retain a perpendicular relationship to the ground surface during an in-use condition 160.

Referring now to FIG. 4 showing a perspective view illustrating hitch hoist system 100 in an in-use condition 160 as ‘hooked’ to the object being lifted and rotated for placement in vehicle 104 according to an embodiment of the present invention of FIG. 2.

In-use condition 160 may include both lifting and rotating (FIGS. 3a and 3b) or stationary positions as shown in FIG. 2. Portable hitch hoist system 102 as previously mentioned comprises beam 180 (boom arm) which may be adjustable in relation to frame 170 (preferably while not in in-use condition 160.) As such beam 180 is able to rotate through a full 360 degrees. In this way an item may be lifted from behind vehicle 104 and set in vehicle 104 or on another suitable transportation means such as a trailer.

Referring now to FIG. 5A, a perspective view of a disassembled kit 500 of hitch hoist system 100 (for transport or storage) according to an embodiment of the present invention of FIGS. 2-4.

Portable hitch hoist system 100 may comprise a kit 500, kit 500 including: at least one first leg jack 110; at least one second leg jack 120; at least one coupler 130; a plurality of connectors 140; frame 170 having beam 180; at least one winch 190; and a set of user instructions. Portable hitch hoist system 102 is disassembleable during a non-use period for storage and/or transport. Portable hitch hoist system 100 may be sold as kit 500 and may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different winch, hydraulic (or non-hydraulic) jacking and lifting combinations, parts may be sold separately, etc., may be sufficient.

FIG. 5B is a perspective view of winch 190 of hitch hoist system 100 according to an embodiment of the present invention of FIGS. 2-5A. Winch 190 is removably coupled to frame 170 such that the windable (spooled) cable 192 is able to be attached to at least one liftable item to be moved vertically and/or horizontally within a work envelope via beam 180, beam 180 being manipulatable by a hydraulic ram 182 (operated manually or non-manually by the user.)

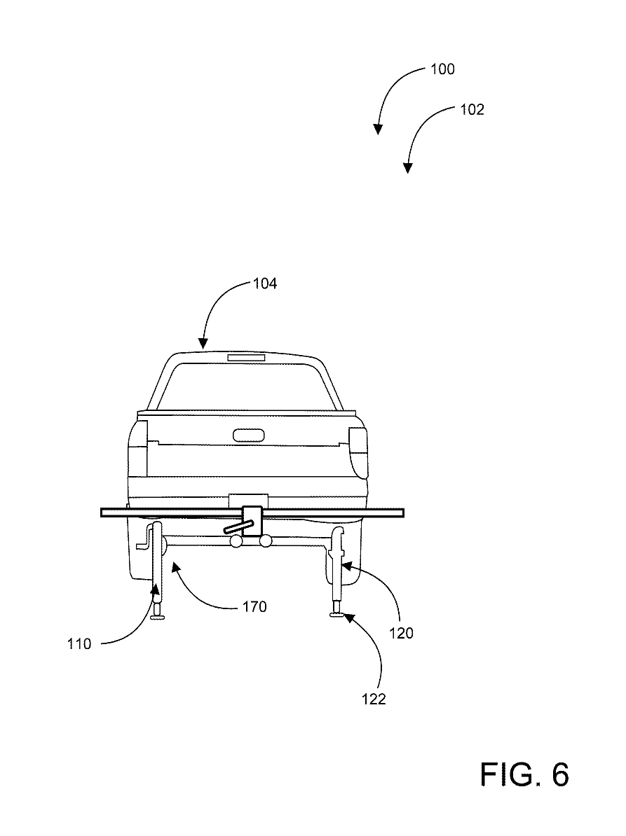

FIG. 6 is a perspective view of another use for hitch hoist system 100 as used to provide a mobile work center using a vice according to an embodiment of the present invention of FIG. 2.

As shown hitch hoist system 100 may take the form in many embodiments and for use in many different applications. The vice may be coupled within hitch hoist system 100 such that it provides a readily available means by which a pipe or other may be held and worked on (in a stable fixed position.) In this way the user is able to conveniently and comfortably work on various projects in remote areas. As envisioned this would work well for oilfield workers, welders, farmers, mechanics and the like. In this way portable hitch hoist system 102 is able to be used as vice-holder workbench.

A method for using portable hitch hoist system 102 preferably comprises the steps of: inserting coupler 130 as a connection to a hitch receiver 106 located on vehicle 104; assembling portable hitch hoist system 102 including first leg jack 110, a second leg jack 120, coupler 130, frame assembly 172 including beam 180, and winch 190 to coupler 130 via a plurality of connectors 140; operating assembled portable hitch hoist system 102 using vehicle 104 as an anchor to lift at least one movable item; and disassembling portable hitch hoist system 102 and storing for at least one future use.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A portable hitch hoist system comprising:
at least one first leg jack;
at least one second leg jack;
at least one coupler;
a plurality of connectors;
a frame having a beam, said beam being hydraulically-operated; and
at least one winch with a windable cable with a hook;
wherein said first leg jack and said second leg jack are coupled together via said coupler;
wherein said coupler provides a connection to a hitch receiver located on a vehicle;
wherein said plurality of connectors are used to connect said beam to said frame, said first leg jack and said second leg jack to said coupler, said coupler to said hitch receiver;
wherein said winch is removably coupled to said frame such that said windable cable is able to be attached to at least one item to be lifted via said beam, said beam being manipulatable by a hydraulic ram; and
wherein said portable hitch hoist system is removably attachable to said vehicle, said vehicle acting in a capacity of an anchor such that said at least one item is able to be repeatedly moved between unlifted and lifted conditions.

2. The portable hitch hoist system of claim 1 wherein said beam is adjustable in relation to said frame.

3. The portable hitch hoist system of claim 2 wherein said beam as able to rotate through 360 degrees.

4. The portable hitch hoist system of claim 1 wherein said first leg jack comprises a smaller size than said second leg jack.

5. The portable hitch hoist system of claim 1 wherein said coupler comprises a coupling tee.

6. The portable hitch hoist system of claim 1 wherein said second leg jack comprises a drop leg.

7. The portable hitch hoist system of claim 6 wherein said drop leg comprises about 29 inches of travel in relation to said frame.

8. The portable hitch hoist system of claim 1 wherein said connectors comprise hitch pins.

9. The portable hitch hoist system of claim 1 wherein said first leg jack comprises a stabilizer.

10. The portable hitch hoist system of claim 5 wherein said coupling tee is used to couple said first leg jack and said second leg jack to said hitch receiver.

11. The portable hitch hoist system of claim 1 wherein said first leg jack can hold up to about 2000 pounds.

12. The portable hitch hoist system of claim 1 wherein said second leg jack can hold up to about 8000 pounds.

13. The portable hitch hoist system of claim 1 wherein said first leg jack and said second leg jack are independently-operably-adjustable to match a ground surface.

14. The portable hitch hoist system of claim 5 wherein said first leg jack and said coupler comprise an outrigger.

15. The portable hitch hoist system of claim 13 wherein said first leg jack is parallel to said second leg jack and retain a perpendicular relationship to said ground surface during an in-use condition.

16. The portable hitch hoist system of claim 1 wherein said portable hitch hoist system is disassembleable during a non-use period for storage and/or transport.

17. The portable hitch hoist system of claim 1 wherein said portable hitch hoist system is transportable in a coupled relationship to said hitch receiver, wherein said first leg jack and said second leg jack are in retracted positions.

18. A portable hitch hoist system comprising:
at least one first leg jack;
at least one second leg jack;
at least one coupler, said coupler comprising a coupling tee;
a plurality of connectors;
a frame having a beam, said beam being hydraulically-operated and adjustable in relation to said frame; and
at least one winch with a windable cable with a hook;
wherein said first leg jack and said second leg jack are coupled together via said coupler;
wherein said first leg jack comprises a smaller size than said second leg jack;
wherein said first leg jack comprises a stabilizer;
wherein said second leg jack comprises a drop leg;
wherein said drop leg is able to move about 29 inches of travel in relation to said frame;
wherein said first leg jack can hold up to about 2000 pounds;
wherein said second leg jack can hold up to about 8000 pounds;
wherein said first leg jack and said second leg jack are independently-operably-adjustable to match a contour of a ground surface;
wherein said first leg jack and said coupler in combination comprise an outrigger;
wherein said first leg jack is parallel to said second leg jack and retain a perpendicular relationship to said ground surface during an in-use condition;
wherein said coupler provides a connection to a hitch receiver located on a vehicle;
wherein said connectors comprise hitch pins;
wherein said coupling tee is used to couple said first leg jack and said second leg jack to said hitch receiver;
wherein said plurality of connectors are used to connect said beam to said frame, said first leg jack and said second leg jack to said coupler, and said coupler to said hitch receiver;
wherein said portable hitch hoist system is disassembleable during a non-use period for storage and/or transport;
wherein said portable hitch hoist system is transportable in a coupled relationship to said hitch receiver, wherein said first leg jack and said second leg jack are in retracted positions;
wherein said winch is removably coupled to said frame such that said windable cable is able to be attached to at least one liftable item to be moved vertically and/or horizontally within a work envelope via said beam, said beam being manipulatable by a hydraulic ram;
wherein said boom as able to rotate through 360 degrees;
wherein said portable hitch hoist system is able to be used as vice-holder workbench; and
wherein said portable hitch hoist system is removably attachable to said vehicle, said vehicle acting in a capacity of an anchor such that said at least one item is able to be repeatedly moved between unlifted and lifted conditions.

19. The portable hitch hoist system of claim 18 wherein said portable hitch hoist system comprises a kit, said kit including:
said at least one first leg jack;
said at least one second leg jack;
said at least one coupler;
said plurality of connectors;
said frame having a beam;
said at least one winch; and
a set of user instructions.

20. A method for using a portable hitch hoist system comprising the steps of:
inserting a coupler as a connection to a hitch receiver located on a vehicle;
assembling said portable hitch hoist system including a first leg jack, a second leg jack, a coupler, a frame assembly including a beam, and a winch to said coupler via a plurality of connectors;
operating said assembled portable hitch hoist system using said vehicle as an anchor to lift at least one movable item; and
disassembling said portable hitch hoist system and storing for at least one future use.
